(19) United States
(12) Patent Application Publication
(10) Pub. No.: US 2026/0021330 A1
(43) Pub. Date: Jan. 22, 2026

(54) Valve Adapter for Breathing Apparatus

(71) Applicant: Dräger Safety AG & Co. KGaA, Lübeck (DE)

(72) Inventors: James Andrew Farnaby, Gosforth (GB); Emilie Lageat, Morpeth (GB)

(21) Appl. No.: 19/271,100

(22) Filed: Jul. 16, 2025

(30) Foreign Application Priority Data
Jul. 16, 2024 (EP) 24188998.9

(51) Int. Cl. A62B 9/02

(52) U.S. Cl. CPC A62B 9/02

(57) ABSTRACT

There is disclosed a valve adapter for a first stage pressure reducer comprising: an inlet port in fluid communication with a high flow non-return valve and comprising a first interfacing portion configured to interface with a connector of the first stage pressure reducer; and a primary outlet port comprising a second interfacing portion configured to interface with a pressure relief valve; wherein a geometry of the first interfacing portion corresponds to a geometry of the second interfacing portion, such that the valve adapter can be placed in-line between the connector of the first stage pressure reducer and the pressure relief valve. Also disclosed is a first stage pressure reducer apparatus comprising a first stage pressure reducer, a pressure relief valve, and a valve adapter. Further disclosed is a breathing system comprising a first stage pressure reducer apparatus.

### CROSS-REFERENCE TO RELATED APPLICATIONS

This application claims the priority of European Patent Application No. 24188998.9, filed on 16 Jul. 2024, the entire contents of which being fully incorporated herein by reference.

### BACKGROUND

Self-contained breathing apparatus (SCBA) products are typically used by fire fighters to provide safe breathing gas in environments with contaminated atmospheres. Typical SCBA products have a high-pressure system which includes a breathing gas tank at a nominal pressure of around 300 bar. The high-pressure system is connected to a medium-pressure system via first stage pressure reduction device. Such devices output breathing gas from the high-pressure system into the medium pressure system at a lower pressure of around 7 bar. This medium pressure breathing gas may then pass through a second stage pressure reduction device to further reduce the pressure to a level suitable for a user to breathe.

Between the output of the first stage pressure reduction device and the medium-pressure system, and as part of the required functionality of SCBA products, a pressure relief valve and a non-return valve must be provided. Such pressure relief valves prevent an over pressurisation of the medium-pressure system, while such non-return valves prevent fluid from flowing to undesirable locations in the pneumatics system.

SCBA systems must be capable of providing adequate flowrates of breathing gas to sustain a user during physically strenuous activity. They must also be capable of functioning at extremely low temperatures and in dusty conditions or in atmospheres with suspended particulates such as smoke or sand.

There exists a need for a new type of valve adapter which can be used to provide the required valves to a SCBA system while also functioning in the extreme conditions SCBA systems must withstand.

### SUMMARY

In a first aspect there is provided a valve adapter for a first stage pressure reducer comprising: an inlet port in fluid communication with a high flow non-return valve and comprising a first interfacing portion configured to interface with a connector of the first stage pressure reducer; and a primary outlet port comprising a second interfacing portion configured to interface with a pressure relief valve; wherein a geometry of the first interfacing portion corresponds to a geometry of the second interfacing portion, such that the valve adapter can be connected in-line between the connector of the first stage pressure reducer and the pressure relief valve.

In use, the connector of the first stage pressure reducer and the pressure relief valve may be capable of both direct connection and connection via the valve adapter. In other words, the ports of the valve adapter may substantially correspond to the respective connectors of the first stage pressure reducer and the pressure relief valve so that it can be modularly connected therebetween.

High flow should be understood to mean that the non-return valve is suitable for use with a high breathing gas flow rate. Such a non-return valve may have a low pressure drop across the valve. This may be achieved by minimising variance in cross sectional area along the flow path of the non-return valve and/or by minimising the number and severity of turns in the flow path. A typical input pressure into a high-flow non-return valve may be at least 5 bar. Typical values for flow rate through such non-return valves may be in the range of at least 600 SLM (standard litres per minute). In some circumstances, 600 SLM at 5 bar may be the minimum requirement for safe operation of the breathing apparatus.

Corresponds to a geometry should be understood to mean that the dimensions, shapes, contours, and such of the respective interfacing portions are such that the geometry of the first interfacing portion may be compatible with the geometry of the second interfacing portion, such that the two portions may be fluidly connected.

The first interfacing portion may be receivable by the connector of the first stage pressure reducer. The second interfacing portion may be configured to receive the pressure relief valve.

The inlet port of the valve adapter may be a male connector and the connector of the first stage pressure reducer may be a female connector. The primary outlet port may be a female connector which has the same geometry as the connector of the first stage pressure reducer. Alternatively, the inlet port may be a female connector. In this case, the connector of the first stage pressure reducer and the primary outlet port may be male connectors with geometries corresponding to the female inlet port.

The valve adapter may comprise at least one additional outlet port in a manifold arrangement so as to permit breathing gas to flow from the inlet port to the primary outlet port and the at least one additional outlet port. Such additional outlet ports may have the same or different geometries than the geometry of the primary outlet port. Each outlet port may be arranged parallel to one another, in a T or V-shaped configuration or in any other way.

The non-return valve of the valve adapter may comprise a valve element comprising a shoulder configured to abut a face of the inlet port. The position of the shoulder may correspond to a maximum open position of the non-return valve. The valve element may be constrained to move axially inside the inlet port. The non-return valve may also comprise a valve seat against which the valve element may be configured to seal. The valve seat may be formed of a curved section of the connecter of the first stage pressure reducer. The non-return valve may be formed by the valve element being placed inside the inlet port of the valve adapter, then connecting the inlet port to the connector.

Alternatively, the non-return valve may be an integral part of the valve adapter, optionally being constrained to move exclusively within the inlet port of the valve adapter.

A clip may retain the valve adapter in the connector of the first stage pressure reducer. The clip may be insertable through an opening in the connector and receivable by an annular notch on the valve adapter. The clip may cooperate with a sealing element to seal the clip inside the opening of the connector, thereby inhibiting an ingress of fluid or debris into the connector and thus the inlet port. The sealing element may be a sealing portion comprised in the clip. The sealing element may be a sealing gasket separate to the clip and/or fixedly attached to the clip. The sealing portion may be formed of a deformable material such as rubber or silicone. Alternatively, the clip may be covered entirely in a deformable material instead of having a discrete sealing portion disposed on its surface. The sealing gasket may be formed of a rigid material such as rigid plastic. The sealing gasket may contain conical (e.g., frustoconical) portions.

The clip may be U or C-shaped. Each tine of the clip may be insertable through a respective opening of the connector and into the annular notch on the valve adapter.

The pressure relief valve may comprise an annular ingress seal disposed at the pressure relief valve vent. The annular ingress seal may be configured to inhibit an ingress of fluid or debris into the pressure relief valve through the pressure relief valve vent.

The annular ingress seal may be formed of a deformable material. The annular ingress seal may have a venting configuration in which the annular ingress seal may deform in response to internal pressure to thereby allow breathing gas to escape from the pressure relief valve vent, and a sealing configuration, in which the annular ingress seal seals the pressure relief valve vent, thereby inhibiting fluid or debris from entering the pressure relief valve vent.

An interface between the inlet port of the valve adapter and the connector of the first stage pressure reducer may be configured to be sealed by an annular interface seal such as a rubber or silicone O-ring.

In a second aspect, there is provided a first stage pressure reducer apparatus comprising a first stage pressure reducer, a pressure relief valve, and a valve adapter as described above.

In a third aspect, there is provided a breathing system comprising a first stage pressure reducer apparatus as described above.

In another aspect, there is provided a pressure relief valve retaining apparatus comprising a clip and an annular notch as described above.

In a further aspect, there is provided a pressure relief valve comprising an ingress protection apparatus itself comprising an annular ingress seal as described above.

### BRIEF DESCRIPTION OF THE DRAWINGS

Arrangements of the disclosure will now be described by way of example and with reference to the accompanying drawings, in which:

FIG. 1 shows a cross sectional view of a known valve adapter connected between a first stage pressure reducer and a pressure relief valve;

FIG. 2A shows a cross sectional view of another known valve adapter connected between a first stage pressure reducer and a pressure relief valve;

FIG. 2B shows a cross sectional view of a known arrangement of a pressure relief connected directly to a first stage pressure reducer.

FIG. 3A shows a cross sectional view of a valve adapter in accordance with an embodiment of the present disclosure;

FIG. 3B shows cross sectional view of a pressure relief valve connected directly to a first stage pressure reducer in accordance with an embodiment of the present disclosure;

FIGS. 4A and 4B show cross sectional views of retaining clips in accordance with embodiments of the present disclosure; and

FIG. 5 shows a cross sectional view of an ingress seal in accordance with an embodiment of the present disclosure.

### DETAILED DESCRIPTION OF THE DRAWINGS

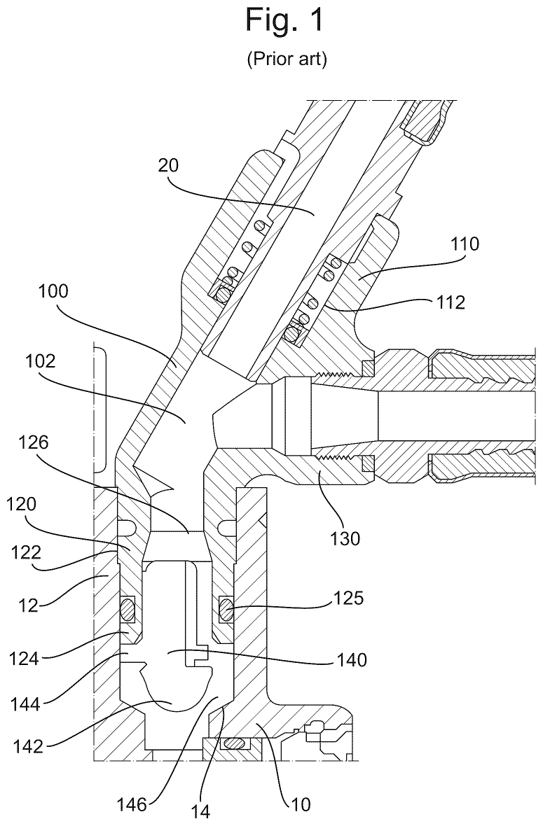

With reference to FIG. 1, an example of a valve adapter 100 known in the art is shown. The valve adapter 100 (also referred to as an adapter 100) is configured to connect a first stage pressure reducer 10 (also referred to as a reducer 10) to a pressure relief valve 20 (also referred to as a relief valve 20) via a connector 12 of the reducer 10. The relief valve 20 may be further connected to a breathing gas hose (not shown) to transport breathing gas downstream to, e.g., a face mask for delivery to a user to breathe.

The valve adapter 100 comprises a primary outlet port 110 which itself comprises an outlet port interfacing portion 112. The outlet port interfacing portion 112 is shaped to receive the relief valve 20. The valve adapter 100 also comprises an inlet port 120 which itself comprises an inlet port interfacing portion 122. The inlet port interfacing portion 122 is shaped to be received by the connector 12 of the reducer 10.

Some known adapters also incorporate an additional outlet port 130, to which other equipment can be connected. Such other equipment may include, for instance, a pressure monitor or gauge, or a secondary breathing gas hose for a supplementary or ‘buddy’ breathing gas supply. These adapters may be said to be in a manifold arrangement, with one inlet (inlet port 120) and multiple outlets (primary outlet port 110 and additional outlet port 130). Breathing gas is able to flow from the inlet port 120 to both the primary outlet port 110 and the additional outlet port 130.

The valve adapter 100 is also in communication with a high-flow non-return valve 140 (also referred to as a non-return valve 140). The non-return valve 140 comprises a valve element 142 which can seal against a seal seat 14 formed at a narrowed portion inside the connector 12 of the reducer 10. When breathing gas flows from the reducer 10 into the adapter 100, the non-return valve 140 is pushed upwards (with respect to FIG. 1) towards the adapter 100 until a shoulder 144 of the non-return valve 140 contacts a lip 124 of the inlet port 120. This upward movement causes the valve element 142 to lift off from the seal seat 14, which in turn forms a flow path 146 for the breathing gas to flow through. If fluid begins to flow in the opposite direction (from the adapter 100 to the reducer 10) the force of the flow causes the non-return valve 140 to move downwards, closing the flow path 146 and resulting in the valve element 142 sealing against the seal seat 14, thereby preventing fluid returning to the reducer 10.

Before the inlet port 120 of the adapter 100 is connected to the reducer 10, the non-return valve 140 is placed inside the inlet port 120. The inlet port 120 is then pushed into the connector 12, causing the non-return valve 140 to be secured into place. At this point, the non-return valve 140 cannot move apart from to move up and down inside the inlet port 120 according to its function.

As shown in FIG. 1, the adapter 100 incorporates a large diameter internal chamber 102, which is connected to a channel 126 of a similar diameter inside the inlet port 120. These similar, large diameters enable an adequate flow rate of at least 600 SLM at a pressure of at least 5 bar, thereby enabling the high-flow non-return valve 140 to deliver adequate breathing gas to a user. The narrowest point through the high-flow non-return valve 140 may generally have a cross sectional area of around 28 mm² to support this flow rate.

Such known adapters 100 often suffer from weakness in the inlet port 120, especially around the sealing O-ring 125, as the inlet port 120 must be particularly thin at this point to provide adequate space for the channel 126 to achieve the desired flow rates.

Known designs of valve adapters such as the valve adapter 100 are used when it is necessary to use a non-return valve 140 and relief valve 20 together. In situations where a non-return valve is not needed (for instance when a different piece of equipment integrates the non-return valve), these designs do not permit the relief valve 20 to be connected directly to the connector 12 of the reducer 10 as their geometries do not correspond. To overcome this, other designs have been developed.

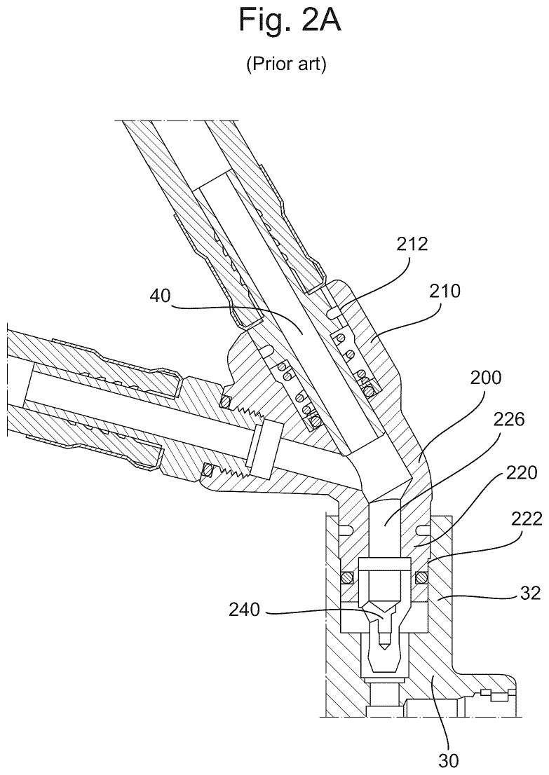

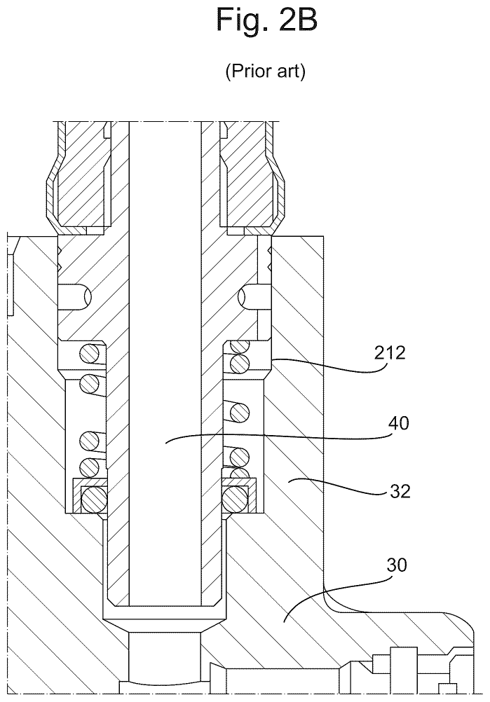

For instance, valve adapter 200 (another design known in the art), shown in FIG. 2A has a primary outlet port 210 comprising an outlet port interfacing portion 212. Adapter 200 also has an inlet port 220 comprising an inlet port interfacing portion 222. The inlet port interfacing portion 222 has an external geometry which corresponds to an internal geometry of the outlet port interfacing portion 212. This allows the relief valve 40 to either connect to the reducer 30 via the primary outlet port 210 of the adapter 200 or directly into the reducer 30 via the connector 32, as shown in FIG. 2B.

In order to enable both the primary outlet port 210 and the connector 32 to have the same internal geometries, thereby allowing each to accept the relief valve 40, this prior design utilises a narrow channel 226 inside the inlet port 220 unlike the wide channel 126 shown in FIG. 1. This allows the inlet port 220 to be shaped correctly, but means the maximum flow rate through the adapter 200 is reduced. Therefore, a standard (not high-flow) non-return valve 240 is used. In contrast to a high-flow non-return valve, the standard non-return valve 240 exhibits a lower maximum flow rate and a greater pressure drop. The narrowest point through the non-return valve 240 may generally have a cross sectional area of around 15 mm²—substantially less than that of the prior art high-flow non-return valve of FIG. 1 (at 28 mm²). Thus, in some cases, the maximum flow rate through the adapter 200 could be less than 550 SLM at 5 bar-substantially lower than the required 600 SLM at 5 bar. In fact, a pressure of between 5.5 bar and 6 bar may be required to achieve a minimum flow rate of 600 SLM. Thus, the airflow performance of the adapter 200 may be reduced. Therefore, while the design shown in FIGS. 2A and 2B allows the relief valve 40 to be connected to the reducer 30 either directly or via the adapter 200, it does not support the high breathing flow rates required.

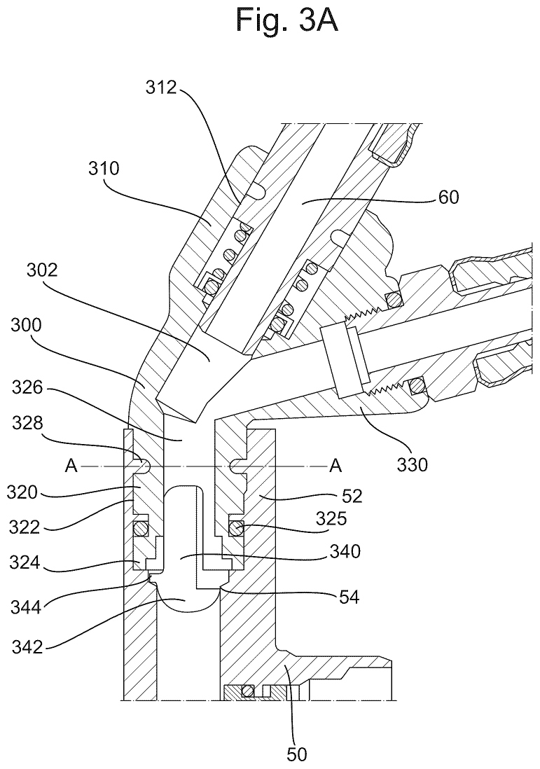

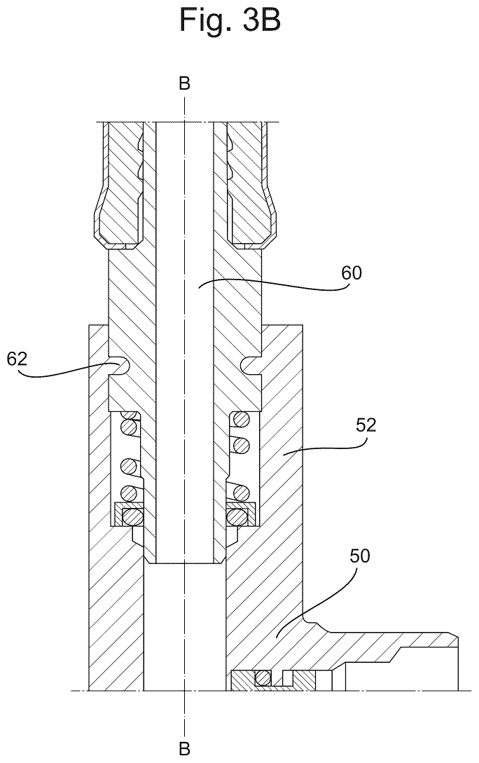

FIG. 3A shows a cross sectional view of a valve adapter 300 according to the present disclosure. The adapter 300 incorporates a primary outlet port 310 with an outlet port interfacing portion 312. The adapter 300 also incorporates an inlet port 320 with an inlet port interfacing portion 322. This inlet port interfacing portion 322 has an external geometry which corresponds to an internal geometry of the outlet port interfacing portion 312. As a result, the connector 52 of the reducer 50 is capable of accepting either the inlet port 320 of the adapter 300, or alternatively the pressure relief valve 60 directly, as shown in FIG. 3B. Like the design shown in FIGS. 2A and 2B, arrangements according to the present disclosure enable both direct connection of the relief valve 60 to the reducer 50 and indirect connection via the adapter 300.

Although the present embodiment described includes a relief valve 60 with a ‘male’ connector receivable by the ‘female’ outlet port interfacing portion 312, and a male inlet port interfacing portion 322 receivable by the female connector 52 of the reducer 50, the principles of the disclosure can equally be applied if these were reversed. For instance, in a different embodiment according to the disclosure, the adapter has a male outlet port interfacing portion which is receivable by a relief valve with a female connector. Such an adapter also has a female inlet port interfacing potion which receives a male connector of the reducer. In this alternative embodiment, the female connector of the relief valve can also receive the male connector of the reducer. This is the opposite of the embodiment shown in FIG. 3B, where the male connector of the relief valve 60 is received by the female connector 52 of the reducer 50.

This arrangement results in the valve adapter 300 being functionally invisible to the relief valve 60 and reducer 50. As a result, a user is able to quickly swap the adapter 300 in or out of their breathing system (for instance to add an additional outlet port) without needing to use a different relief valve 60 with a differently shaped interfacing portion. Adapter 300 reduces wastage of equipment by allowing differently shaped components to function together. For instance, the adapter 300 according to the present disclosure may have an additional outlet port 330 comprising an interfacing portion with an “old style” internal geometry, while the inlet port interfacing portion 322 and outlet port interfacing portion 312 geometries may be a “new style”. This would therefore allow a user to connect a piece of equipment such as a pressure gauge which uses an “old style” interface to the valve adapter 300 while maintaining functionality with their “new style” reducer 50 and connector 52. In this situation, the user benefits from the high-flow characteristics of the adapter 300, while also being able to use legacy equipment such as a breathing gauge which may still be perfectly functional but does not have the “new style” interface.

The valve adapter 300 also incorporates a high-flow non-return valve 340 similar to the high-flow non-return valve 140 used in the design shown in FIG. 1. FIG. 3A shows the non-return valve 340 in a closed configuration, where the valve element 342 is in contact with the valve seat 54 formed at a narrowed portion of the connector 52. The shoulder 344 of the non-return valve is shown separated from the lip 324 of the inlet port 320. The non-return valve 340 has a narrowest cross sectional area of around 20 mm² which, while lower than the corresponding area of the prior art non-return valve 140 of FIG. 1, is still large enough to support the minimum required flow rate (600 SLM at 5 bar), while taking up significantly less space. To complement the high-flow non-return valve 340, the adapter 300 also incorporates a wide diameter chamber 302 and a channel 326 of a similar diameter inside the inlet port 320. These help to minimise any pressure drop as the breathing gas passes from one part of the adapter 300 to another.

The valve adapter 300 is therefore able to support a minimum flow rate of at least 600 SLM at 5 bar-meeting the requirements for operation-while still providing for a more customisable system. In some embodiments, the valve adapter 300 may support a minimum flow rate of between 600 SLM and 610 SLM at 5 bar. In some embodiments, the valve adapter 300 may support a minimum flow rate of 604 SLM at 5 bar.

The combination of the high-flow non-return valve 340 and the corresponding geometries of the inlet port 320 and primary outlet port 310 enable the adapter 300 to support high airflow performance while also supporting backwards and/or interoperable compatibility.

The valve adapter 300 may also comprise an annular interface seal 325 disposed around the inlet port 320. The annular interface seal 325 is compressed between the inlet port interfacing portion 322 and the connector 52 of the reducer 50 when the adapter 300 is installed, thereby forming an airtight seal. The annular interface seal 325 helps to reduce leakage of breathing gas and also helps to reduce the likelihood of fluid or debris ingress between the inlet port 320 and the connector 52.

In some embodiments, the valve adapter 300 also includes thickened sections of the inlet port 320 proximate the annular interface seal 325 to reduce the risk of breakage in this area. While this may narrow the channel 326 to a small extent as compared to the adapter 100 of FIG. 1 (described above in terms of cross sectional area), the strength improvements are significant and the channel 326 is still wide enough to support at least 600 SLM at 5 bar.

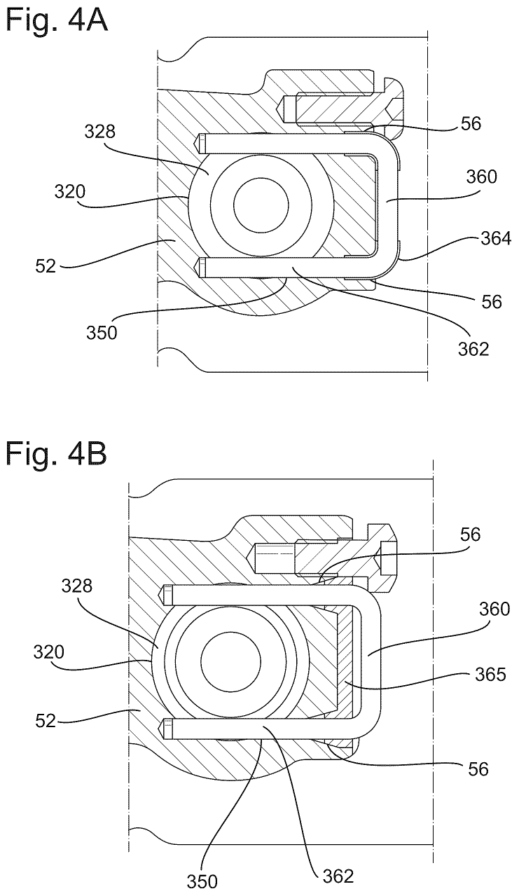

FIG. 4A shows a transverse cross-sectional view of the inlet port 320 as labelled A-A in FIG. 3A. As shown in FIGS. 3A and 4, the inlet port 320 comprises an annular notch 328. The connector 52 of the reducer 50 comprises two openings 56 in the side of the connector 52. After the inlet port 320 is inserted into the connector 52, each tine 362 of a U-clip 360 can be pushed into a respective opening 56. Once the U-clip 360 is pushed completely into the openings 56, each tine 362 passes through the annular notch 328. In this position, the inlet port 320 (and by extension, the adapter 300) cannot be disconnected from the reducer 50.

The U-clip 360 comprises sealing portions 364 at the corners of the U-clip 360. Once the U-clip 360 is inserted into the openings 56, these sealing portions 364 seal any spaces between the U-clip 360 and the openings 56. Therefore, ingress of any fluids or debris into the inlet port 320 is inhibited. This measure helps to reduce the risk of contaminants impacting the performance of or potentially causing damage to the breathing system. In some embodiments, either a single rod or a clip with more than two tines may be used instead of a U-clip 360 to secure the inlet port 320 in place, using the same principles.

A similar clip can also be used to secure the relief valve 60 into the reducer 50 directly when the adapter 300 is not used. As shown in FIG. 3B, the relief valve 60 comprises an annular recessed portion 62 similar to the annular notch 328 shown in FIG. 3A. This allows a clip such as the U-clip 360 of FIG. 4A to be inserted through the openings 56 in the connector 52 and used to secure the relief valve 60 in place.

Similar to FIG. 4A, FIG. 4B shows a transverse cross-sectional view of the inlet port 320 as labelled A-A in FIG. 3A. In this embodiment, the sealing portions 364 are replaced by a sealing gasket 365. The sealing gasket 365 may be formed of rigid plastic. The sealing gasket 365 seals any spaces between the U-clip 360 and the openings 56. The sealing gasket 365 may be fixedly attached to the U-clip 360. The sealing gasket 365 may alternatively be a separate component comprising holes through which the tines of the U-clip 360 are installed. As shown in FIG. 4B, the sealing gasket 365 may comprise conical (e.g., frustoconical) portions which enable the sealing gasket 365 to securely seal against the openings 56. To aid in forming a secure seal, the openings 56 may also comprise a conical (e.g., frustoconical) internal shape, complementary to the shape of the sealing gasket 365.

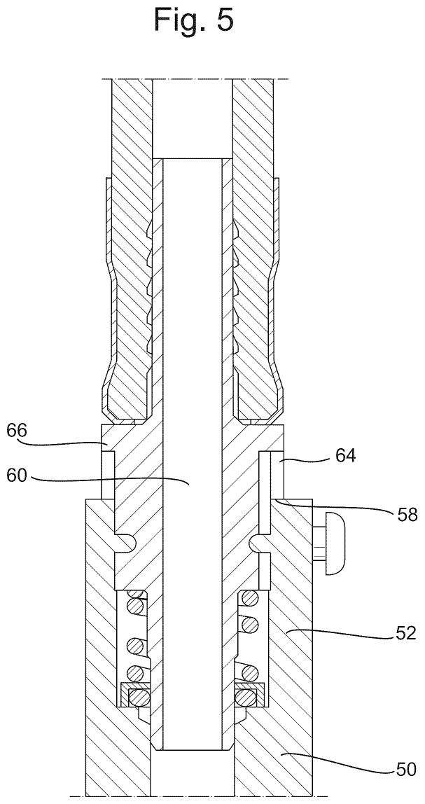

FIG. 5 shows a cross sectional view of the reducer 50 and relief valve 60 when directly connected, as labelled B-B in FIG. 3B. When the relief valve 60 vents overpressure breathing gas, the breathing gas escapes through an annular vent 58. It is important that the vent 58 does not allow fluid or other debris to enter the relief valve 60 or connector 52. Breathing systems such as those applicable to the present disclosure are designed to function in a wide range of temperature conditions including freezing conditions. If a fluid enters through the vent 58, it may freeze inside the relief valve 60, causing the relief valve 60 to fail. The relief valve 60 is important for the safe operation of the system and safety of the user.

As shown in FIG. 5, an annular ingress seal 64 is provided around the relief valve 60 and in contact with the vent 58. The annular ingress seal 64 is made from a deformable material and is fixed to the relief valve 60 at an annular fixing point 66. When the relief valve 60 begins to vent breathing gas, the pressure of the breathing gas leaving the vent 58 causes the annular ingress seal 64 to deform and compress, thereby lifting off from the vent 58 and allowing the vented breathing gas to escape. When the relief valve 60 is not venting, the annular ingress seal 64 returns to its default shape, applying pressure to the vent 58, sealing it closed. Fluid or debris is therefore inhibited from entering the inlet port 320.

It should be appreciated that the embodiments disclosed are just some examples of the many possible configurations in accordance with the present disclosure. When another configuration is used, it should be understood that the principles of the present disclosure could be applied and adapted to provide a valve adapter in accordance with the present disclosure.

1. A valve adapter for a first stage pressure reducer comprising:
a first interfacing portion configured to interface with a connector of the first stage pressure reducer; and
a primary outlet port comprising a second interfacing portion configured to interface with a pressure relief valve;
wherein the valve adapter further comprises an inlet port in fluid communication with a high flow non-return valve; and
wherein a geometry of the first interfacing portion corresponds to a geometry of the second interfacing portion, such that the valve adapter can be connected in-line between the connector of the first stage pressure reducer and the pressure relief valve.

2. The valve adapter of claim 1, wherein the first interfacing portion is configured to be received the connector of the first stage pressure reducer and wherein the second interfacing portion is configured to receive the pressure relief valve.

3. The valve adapter of claim 1, further comprising an at least one additional outlet port in a manifold arrangement with the valve adapter so as to permit fluid to flow from the inlet port to the primary outlet port and the at least one additional outlet port.

4. The valve adapter of claim 3, wherein the geometry of the at least one additional outlet port differs from the geometry of the primary outlet port.

5. The valve adapter of claim 1, wherein the non-return valve comprises
a valve element comprising a shoulder configured to abut a face of the inlet port;
wherein the position of the shoulder corresponds to a maximum open position of the non-return valve:
wherein the valve element is constrained to move axially inside the inlet port; and
wherein the non-return valve further comprises a valve seat against which the valve element is configured to seal.

6. The valve adapter of claim 1, wherein a clip retains the valve adapter in the connector of the first stage pressure reducer, the clip being insertable through an opening of the connector of the first stage pressure reducer and receivable by an annular notch on the valve adapter.

7. The valve adapter according to claim 6, wherein the clip cooperates with a sealing element to seal the clip inside the opening of the connector of the first stage pressure reducer, thereby inhibiting an ingress of fluid or debris into the connector of the first stage pressure reducer.

8. The valve adapter according to claim 6, wherein the clip is U-shaped or C-shaped;
wherein the clip comprises at least one tine; and
wherein each tine of the clip is insertable through a respective opening of the connector and into the annular notch on the valve adapter.

9. The valve adapter according to claim 1, wherein the pressure relief valve comprises an annular ingress seal disposed at a pressure relief valve vent, the annular ingress seal being configured to inhibit an ingress of fluid or debris into the pressure relief valve through the pressure relief valve vent.

10. The valve adapter according to claim 9, wherein the annular ingress seal is configured to deform in response to internal pressure to thereby allow breathing gas to escape from the pressure relief valve vent; and
wherein the annular ingress seal is further configured to seal the pressure relief valve vent when the pressure relief valve vent is not venting, thereby inhibiting fluid or debris from entering the pressure relief valve vent.

11. The valve adapter according to claim 1, wherein an interface between the inlet port and the connector of the first stage pressure reducer is configured to be sealed by an annular interface seal.

12. A first stage pressure reducer apparatus comprising:
a first stage pressure reducer;
a pressure relief valve; and
the valve adapter according to claim 1.

13. A breathing system comprising the first stage pressure reducer apparatus according to claim 12.

14. The valve adapter of claim 5, wherein the valve seat is formed of a curved section of the connector of the first stage pressure reducer, whereby the non-return valve is formed by a connection of the valve adapter and the connector of the first stage pressure reducer.
